(19) United States
(12) Patent Application Publication
(10) Pub. No.: US 2026/0236029 A1
(43) Pub. Date: Aug. 13, 2026

(54) VISIBLE LIGHT INDICATION AND OBJECT DETECTION SYSTEM FOR A GROUND-BASED MOBILITY DEVICE

(71) Applicant: GM Global Technology Operations LLC, Detroit, MI (US)

(72) Inventors: Breona Warren, Sterling Heights, MI (US); Joshua Lee Solomon, Berkley, MI (US); Jesse Heidrich, Shelby Township, MI (US); Rob John Kempf, Austin, TX (US); Hui-ping Wang, Troy, MI (US); Guangze Li, Novi, MI (US)

(21) Appl. No.: 19/052,492

(22) Filed: Feb. 13, 2025

(51) Int. Cl. G05D 1/622; B60Q 1/50; B60Q 5/00; G05D 1/242; G05D 109/10; G05D 111/10; G06V 10/75; G06V 20/58

(52) U.S. Cl. CPC G05D 1/622; G05D 1/242; G06V 10/751; G06V 20/58; B60Q 1/525; B60Q 5/006; G05D 2109/10; G05D 2111/10

(57) ABSTRACT

A visible light indication system for a ground-based mobility device includes one or more visible light sources mounted to a main body of the ground-based mobility device that generate a visible light profile representing a predefined pattern of visible light that is displayed upon a surface that the ground-based mobility device traverses along. The visible light profile extends around a perimeter of the main body of the ground-based mobility device. The visible light indication system also includes one or more cameras positioned on the main body of the ground-based mobility device to collect image data representative of the entirety of the visible light profile and one or more controllers in electronic communication with the one or more visible light sources and the one or more cameras.

### INTRODUCTION

The present disclosure relates to a visible light indication system for a ground-based mobility device.

Autonomous mobile robots are mobile systems that navigate and respond to uncontrolled environments without physical or electromechanical guidance, and also without being limited in movement along a fixed, predetermined path. In one implementation, an autonomous mobile robot may be employed to transport materials within a manufacturing environment. Specifically, the autonomous mobile robot may transport materials from storage or receiving locations to an order fulfillment or point-of-use destination within a manufacturing facility.

Autonomous mobile robots may rely upon LiDAR-based systems to detect the presence of objects that are located along or obstruct their path of motion. However, LiDAR-based systems tend to add complexity to a system, may suffer from crosstalk, create signals that are invisible to the human eye, and may be challenging to incorporate into some existing production systems. In particular, since LiDAR-based systems create signals that are invisible to the human eye, an individual located in the surrounding environment does not know if an autonomous mobile robot has detected his or her presence.

Thus, while current autonomous mobile robots achieve their intended purpose, there is a need in the art for an autonomous mobile robot that addresses the above-mentioned issues.

### SUMMARY

According to several aspects, a visible light indication system for a ground-based mobility device is disclosed. The visible light indication system includes one or more visible light sources mounted to a main body of the ground-based mobility device that generates a visible light profile representing a predefined pattern of visible light that is displayed upon a surface that the ground-based mobility device traverses along. The visible light profile extends around a perimeter of the main body of the ground-based mobility device. The visible light indication system includes one or more cameras positioned on the main body of the ground-based mobility device to collect image data representative of the entirety of the visible light profile and one or more controllers in electronic communication with the one or more visible light sources and the one or more cameras. The one or more controllers execute instructions to monitor the image data representative of the entirety of the visible light profile collected by the one or more cameras as the ground-based mobility device travels along the surface. The one or more controllers detect a deviation in the predefined pattern of visible light displayed upon the surface, where the deviation in the predefined pattern of visible light displayed upon the surface is created as an object encroaches upon the visible light profile. In response to detecting the deviation in the predefined pattern of visible light displayed upon the surface, the one or more controllers compare a size of the deviation in the predefined pattern of visible light displayed upon the surface with a threshold amount of deviation in the predefined pattern of visible light. The one or more controllers determine the size of the deviation in the predefined pattern of visible light displayed upon the surface is greater than threshold amount of deviation in the predefined pattern of visible light, and instruct the ground-based mobility device to perform one or more predefined actions, where the ground-based mobility device executes the one or more predefined actions to avoid contact with the object that encroached upon the visible light profile.

In another aspect, the deviation represents a distortion within the predefined pattern of visible light displayed upon the surface created by the one or more visible light sources.

In yet another aspect, the threshold amount of deviation is based on the size of the object that encroaches upon the visible light profile.

In an aspect, the one or more predefined actions include one or more of the following: ceasing movement of the ground-based mobility device, reducing a speed of the ground-based mobility device, creating an audio alert, creating a visual alert, and changing a trajectory of the ground-based mobility device to avoid the object.

In another aspect, the predefined pattern of visible light includes one or more of the following: one or more straight lines, one or more lines shaped in a zigzag configuration, one or more lines that include a series of dots or dashed lines, letters, and characters.

In yet another aspect, the one or more visible light sources include one or more of the following: an array of light-emitting diodes (LEDs) and visible light lasers.

In an aspect, the one or more controllers execute instructions to instruct the one or more visible light sources to direct the visible light profile including the predefined pattern of visible light in a specific location upon the surface to follow an outer boundary of an object detection field, wherein the object detection represents an area between the main body of the ground-based mobility device and the visible light profile.

In another aspect, the area included by the object detection field is based on a stopping distance of the ground-based mobility device.

In yet another aspect, the one or more controllers execute one or more objection recognition algorithms to identify the object encroaching upon the visible light profile.

In an aspect, a ground-based mobility device includes a main body and a visible light indication system. The visible light indication system includes one or more visible light sources mounted to a main body of the ground-based mobility device that generate a visible light profile representing a predefined pattern of visible light that is displayed upon a surface that the ground-based mobility device traverses along, where the visible light profile extends around a perimeter of the main body of the ground-based mobility device. The visible light indication system one or more cameras positioned on the main body of the ground-based mobility device to collect image data representative of the entirety of the visible light profile and one or more controllers in electronic communication with the one or more visible light sources and the one or more cameras. The one or more controllers execute instructions to monitor the image data representative of the entirety of the visible light profile collected by the one or more cameras as the ground-based mobility device travels along the surface. The one or more controllers detect a deviation in the predefined pattern of visible light displayed upon the surface, where the deviation in the predefined pattern of visible light displayed upon the surface is created as an object encroaches upon the visible light profile. In response to detecting the deviation in the predefined pattern of visible light displayed upon the surface, the one or more controllers compare a size of the deviation in the predefined pattern of visible light displayed upon the surface with a threshold amount of deviation in the predefined pattern of visible light. The one or more controllers determine the size of the deviation in the predefined pattern of visible light displayed upon the surface is greater than threshold amount of deviation in the predefined pattern of visible light, and instruct the ground-based mobility device to perform one or more predefined actions, where the ground-based mobility device executes the one or more predefined actions to avoid contact with the object that encroached upon the visible light profile.

In another aspect, the deviation represents a distortion within the predefined pattern of visible light displayed upon the surface created by the one or more visible light sources.

In yet another aspect, the threshold amount of deviation is based on the size of the object that encroaches upon the visible light profile.

In an aspect, the one or more predefined actions include one or more of the following: ceasing movement of the ground-based mobility device, reducing a speed of the ground-based mobility device, creating an audio alert, creating a visual alert, and changing a trajectory of the ground-based mobility device to avoid the object.

In another aspect, the predefined pattern of visible light includes one or more of the following: one or more straight lines, one or more lines shaped in a zigzag configuration, one or more lines that include a series of dots or dashed lines, letters, and characters.

In yet another aspect, the one or more visible light sources include one or more of the following: an array of LEDs and visible light lasers.

In an aspect, the one or more controllers execute instructions to instruct the one or more visible light sources to direct the visible light profile including the predefined pattern of visible light in a specific location upon the surface to follow an outer boundary of an object detection field, wherein the object detection represents an area between the main body of the ground-based mobility device and the visible light profile.

In another aspect, the area included by the object detection field is based on a stopping distance of the ground-based mobility device.

In yet another aspect, the ground-based mobility device is one of the following: an autonomous mobile robot, a forklift, a tugger, a golf cart, an airport baggage mover, a plane tugger, a motorized bed, and a motorized stretcher.

In an aspect, the ground-based mobility device includes autonomous driving capabilities.

In another aspect, a method of detecting objects by a visible light indication system in a ground-based mobility device is disclosed. The method includes monitoring, by one or more controllers, image data representative of the entirety of a visible light profile collected by one or more cameras as the ground-based mobility device travels along a surface that the ground-based mobility device traverses along, where one or more visible light sources are mounted to a main body of the ground-based mobility device and generate the visible light profile that represents a predefined pattern of visible light that is displayed upon the surface, and wherein the visible light profile extends around a perimeter of the main body of the ground-based mobility device. The method includes detecting a deviation in a predefined pattern of visible light displayed upon the surface, where the deviation in the predefined pattern of visible light displayed upon the surface is created as an object encroaches upon the visible light profile. In response to detecting the deviation in the predefined pattern of visible light displayed upon the surface, the method includes comparing, by the one or more controllers, a size of the deviation in the predefined pattern of visible light displayed upon the surface with a threshold amount of deviation in the predefined pattern of visible light. The method includes determining the size of the deviation in the predefined pattern of visible light displayed upon the surface is greater than threshold amount of deviation in the predefined pattern of visible light. The method includes instructing the ground-based mobility device to perform one or more predefined actions and executing, by the ground-based mobility device, the one or more predefined actions to avoid contact with the object that encroached upon the visible light profile.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A illustrates a ground-based mobility device generating a visible light profile upon a surface that the ground-based mobility device traverses along, according to an exemplary embodiment;

FIG. 1B is an enlarged view of Area 1A shown in FIG. 1, according to an exemplary embodiment;

FIG. 2 is a perspective view of the ground-based mobility device including the disclosed visible light indicator system, according to an exemplary embodiment;

FIG. 3 is an assembly view of the ground-based mobility device shown in FIG. 2, according to an exemplary embodiment;

FIG. 4 is a schematic a top view the ground-based mobility device 10, one or more visible light sources, one or more cameras, and an object detection field of the ground-based mobility device, according to an exemplary embodiment;

FIG. 5A illustrates an object encroaching upon the visible light profile shown in FIG. 1A, according to an exemplary embodiment;

FIG. 5B is an enlarged view of Area 5B shown in FIG. 5A, according to an exemplary embodiment; and

FIG. 6 is a process flow diagram illustrating a method for detecting objects by the visible light indicator system, according to an exemplary embodiment.

### DETAILED DESCRIPTION

The following description is merely exemplary in nature and is not intended to limit the present disclosure, application, or uses.

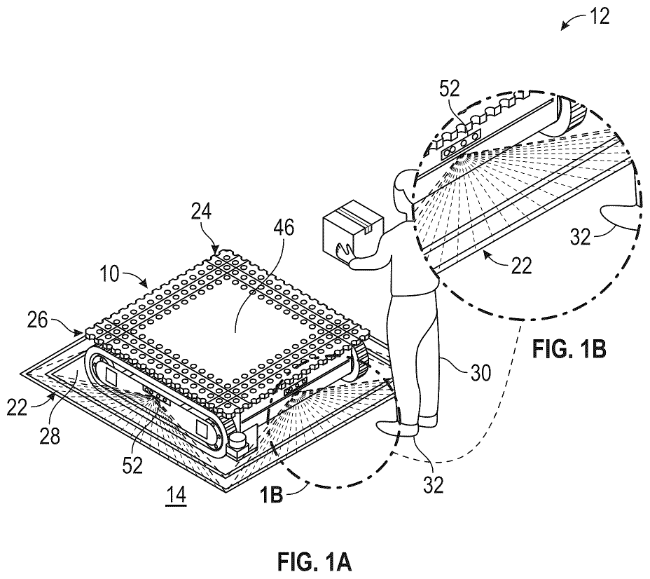

Referring to FIG. 1A, an elevated perspective view of the disclosed ground-based mobility device 10 within a facility 12 is illustrated. The ground-based mobility device 10 may be any type of mobility device that includes a source of motive power such as, for example, an engine or electric motor. The ground-based mobility device 10 may traverse a relatively level surface where humans may potentially be located. In the non-limiting embodiment as shown in the figures and as described below, the ground-based mobility device 10 is illustrated as an autonomous mobile robot and the facility 12 is a manufacturing environment. However, it is to be appreciated that the ground-based mobility device 10 is not limited to a specific application such as an autonomous mobile robot. It is also to be appreciated that the ground-based mobility device 10 is not limited to devices with autonomous driving capabilities and may include other types of ground-based mobility devices that are operated by a human as well. Some examples of other ground-based mobility devices include, but are not limited to, forklifts, tuggers, golf carts, airport baggage movers, plane tuggers, and motorized beds or stretchers. Furthermore, the ground-based mobility device 10 may operate in a variety of environments other than a manufacturing facility such as, for example, an airport or a hospital.

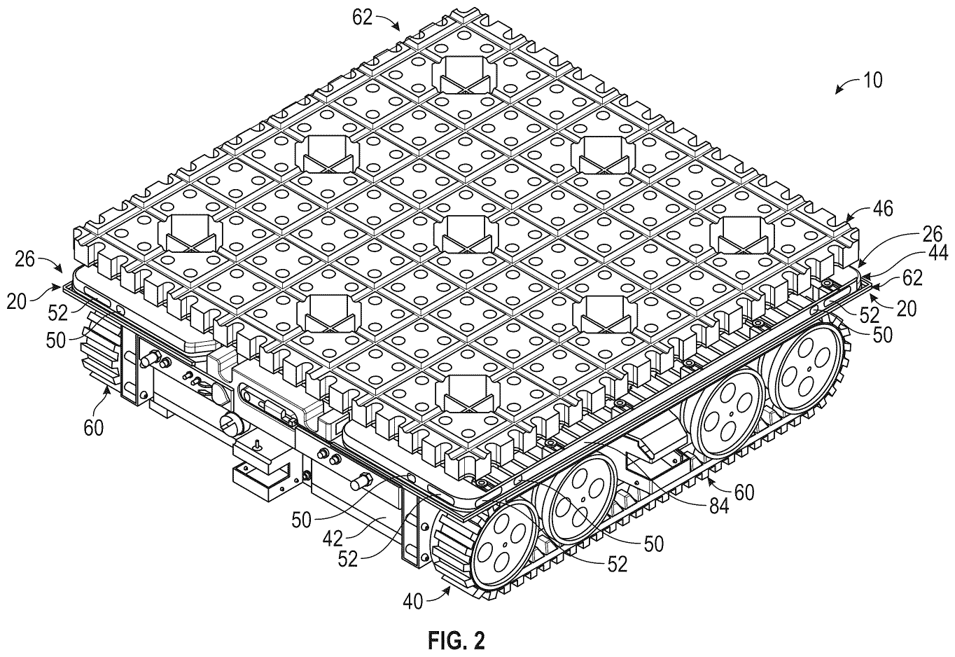

The ground-based mobility device 10 includes a visible light indication system 20 (shown in FIG. 2). The visible light indication system 20 generates a visible light profile 22 that is displayed upon a surface 14 that the ground-based mobility device 10 traverses along. The visible light profile 22 extends around the perimeter 24 of the main body 26 of the ground-based mobility device 10. As explained below, the visible light profile 22 serves as a visible indicator of an object detection field 28 of the ground-based mobility device 10 to one or more individuals 30 located within the surrounding environment. An individual 30 understands that he or she should avoid the object detection field 28 shown upon the surface 14. FIG. 1B is an enlarged view of a portion of the visible light profile 22 situated within proximity to the feet 32 of the individual 30.

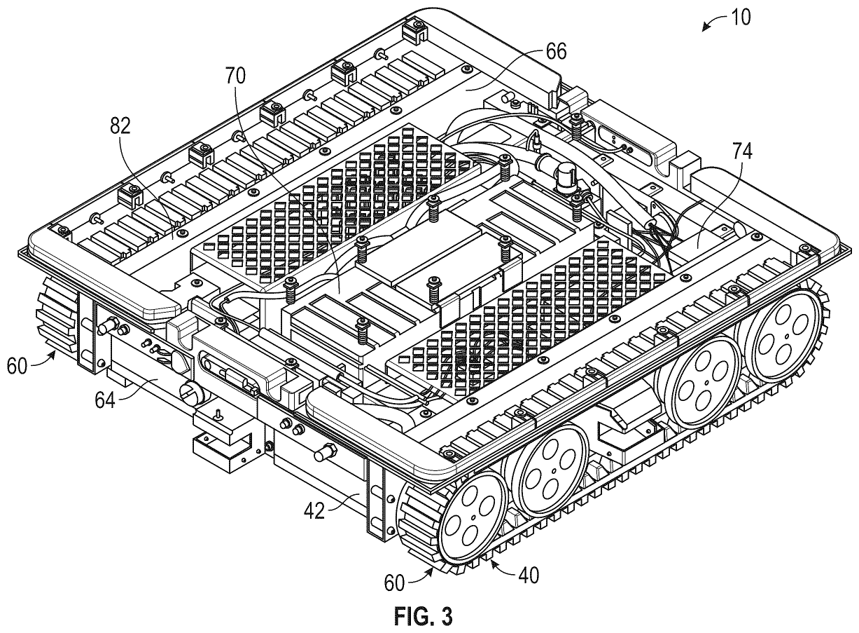

FIG. 2 is a perspective view of the ground-based mobility device 10 and FIG. 3 is an assembly view of the ground-based mobility device 10. Referring to both FIGS. 2 and 3, the ground-based mobility device 10 includes a drive system 40, a chassis 42, a support plate 44, a pallet 46, and one or more rechargeable battery modules (not visible in the figures) that provide electrical power to one or more electric motors (not visible in the figures). The one or more electric motors provide motive power to the autonomous mobile robot. The visible light indication system 20 includes one or more visible light sources 50 and one or more cameras 52.

The drive system 40 propels the ground-based mobility device 10 along the surface 14 (FIG. 1A) of the facility 12. In the non-limiting embodiment as shown in the figures, the drive system 40 includes two track drive systems 60. Each track drive system 60 is attached to one of two opposing sides 62 of the chassis 42. Although the figures illustrate the drive system 40 including two track drive systems 60, it is to be appreciated that other types of drive systems for propelling the ground-based mobility device 10 may be used as well such as, for example, a drive system that includes wheels.

Referring to FIG. 3, the chassis 42 includes a body 64 that defines one or more cavities 66 shaped to contain a plurality of electrical components such as, for example, a housing 70 and one or more controllers 74. The housing 70 contains the one or more rechargeable battery modules (not visible). The one or more rechargeable battery modules may include, for example, a lead-acid or lithium-ion batteries, and provides the electrical power required to operate the ground-based mobility device 10. Referring to both FIGS. 2 and 3, the support plate 44 is a protective plate that is seated on top of an upper surface 82 of the body 64 of the chassis 42 and covers the one or more cavities 66 of the chassis 42. The one or more controllers 74 are in electronic communication with the drive system 40, the one or more battery modules, the one or more visible light sources 50, and the one or more cameras 52.

In the non-limiting embodiment as shown in FIG. 2, the one or more visible light sources 50 and the one or more cameras 52 are mounted along a side surface 84 of the support plate 44. As explained below, the one or more visible light sources 50 generate the visible light profile 22 (shown in FIG. 1A) and the one or more cameras 52 collect image data representative of the entirety of the visible light profile 22. However, it is to be appreciated that the figures are merely exemplary in nature and the visible light sources 50 may be mounted along any portion of the main body 26 of the ground-based mobility device 10 as long as the visible light sources 50 are positioned to generate the visible light profile 22 extends around the perimeter 24 of the main body 26 of the ground-based mobility device 10 and along the surface 14 (FIG. 1A) the ground-based mobility device 10 travels along. Similarly, the one or more cameras 52 may be mounted along any portion of the main body 26 of the ground-based mobility device 10 as long as the one or more cameras 52 are able to collect image data representative of the entirety of the visible light profile 22.

The visible light sources 50 may be any type of device that emits visible light such as, but not limited to, an array of light-emitting diodes (LEDs) and visible light lasers. Referring to FIG. 1A, the visible light profile 22 represents a predefined pattern of visible light that is displayed upon the surface 14 that the ground-based mobility device 10 traverses along that extends around the perimeter 24 of the main body 26 of the ground-based mobility device 10. In the non-limiting embodiment as shown in FIG. 1A, the predefined pattern of visible light includes two straight lines that are parallel to one another. However, it is to be appreciated that FIG. 1A is merely exemplary in nature and the predefined pattern of light may include any number or types of predefined patterns such as, for example, one or more straight lines, one or more lines shaped in a zigzag configuration, one or more lines that include a series of dots or dashed lines, and letters and characters. For example, the predefined pattern may include letters and characters to spell the message “Caution!”. It is also to be appreciated that the predefined pattern of visible light is not limited to any specific wavelength (i.e., color). In one embodiment, the predefined pattern of visible light that changes on demand or based on the surroundings of the ground-based mobility device 10. For example, if a static object is located in the path of travel of the ground-based mobility device 10, the predefined pattern of visible light may be modified to go around the static object as the ground-based mobility device 10 passes.

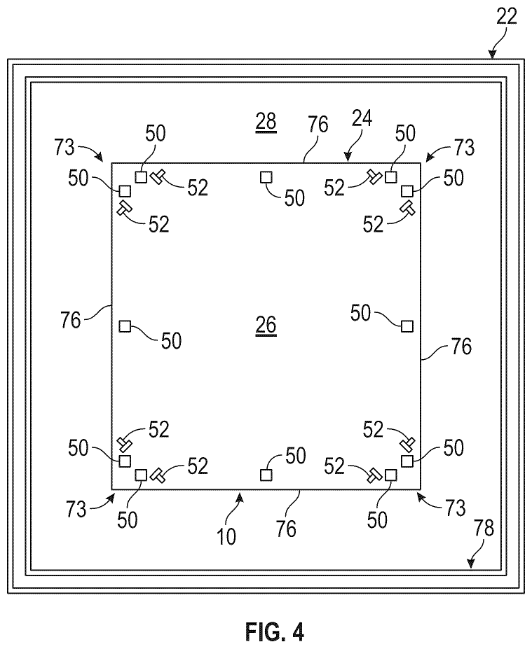

FIG. 4 is a schematic diagram illustrating a top view the ground-based mobility device 10, the one or more visible light sources 50, the one or more cameras 52, and the object detection field 28 of the ground-based mobility device 10. The object detection field 28 represents an area between the main body 26 of the ground-based mobility device 10 and the visible light profile 22. As explained below, the one or more controllers 74 instructs the ground-based mobility device 10 to perform one or more predefined actions to prevent objects that impede travel of the ground-based mobility device 10 from entering the object detection field 28. Some examples of objects impede travel of the ground-based mobility device 10 include, but are not limited to, humans, animals, and mobile machinery such as a forklift. However, smaller sized objects that are inconsequential to the motion of the ground-based mobility device 10 such as, for example, bolts, screws, and pieces of trash such as scraps of paper or food wrappers may be located within the object detection field 28. It is to be appreciated that the predefined pattern of visible light that is displayed upon the surface 14 as part of the visible light profile 22 acts as a visible indicator to individuals in the surrounding environment to avoid the object detection field 28 of the ground-based mobility device 10.

Referring to FIGS. 3 and 4, it is to be appreciated that the specific position of the visible light profile 22 along the surface 14 object detection field 28 of the ground-based mobility device 10 is based on the area included by the object detection field 28. As seen in FIG. 4, the visible light profile 22 is disposed around an outer boundary 78 of the object detection field 28. Thus, the one or more controllers 74 instructs the one or more visible light sources 50 to direct the visible light profile 22 including the predefined pattern of visible light in a specific location upon the surface 14 to follow the outer boundary 78 of the object detection field 28.

The one or more controllers 74 determine the area included by the object detection field 28 based on a stopping distance of the ground-based mobility device 10. The stopping distance of the ground-based mobility device 10 is determined based on one or more of the following factors: the speed of the ground-based mobility device 10, the weight of the payload carried by the ground-based mobility device 10, the type of objects the payload includes, the current location of the ground-based mobility device 10, and the presence of a fault in the ground-based mobility device 10. The type of objects the payload includes may indicate if the ground-based mobility device 10 is transporting sensitive materials that require additional precautions. For example, if the payload includes sensitive materials, then the area included by the object detection field 28 may increase to accommodate a longer stopping distance. The current location of the ground-based mobility device 10 indicates the risk associated with the current location with respect to incidents such as, for example, accidents. In an embodiment, locations associated with a higher risk of accidents may result in increasing the area included by the object detection field 28.

In the non-limiting embodiment as shown in FIG. 4, the ground-based mobility device 10 includes twelve visible light sources 50 and eight cameras 52, where two visible light sources 50 and two cameras 52 are positioned at each corner 73 of the ground-based mobility device 10 and a visible light source 50 is positioned along each edge 76 of the ground-based mobility device 10. However, it is to be appreciated that any number of visible light sources 50 and cameras 52 may be used as long as the visible light profile 22 extends around the perimeter 24 of the main body 26 of the ground-based mobility device 10 and the cameras 52 are positioned on the main body 26 of the ground-based mobility device 10 to collect image data representative of the entirety of the visible light profile 22. That is, in other words, the one or more cameras 52 cover a full 360-degree view around the ground-based mobility device 10. Accordingly, when the one or more cameras 52 include a higher field-of-view, this may result in fewer cameras 52 being required. Similarly, if the one or more cameras 52 include a lower field-of-view, this may result in more cameras 52 being required. It is to be appreciated that the one or more cameras 52 may include any camera capable of capturing images such as, for example, a microcontroller camera.

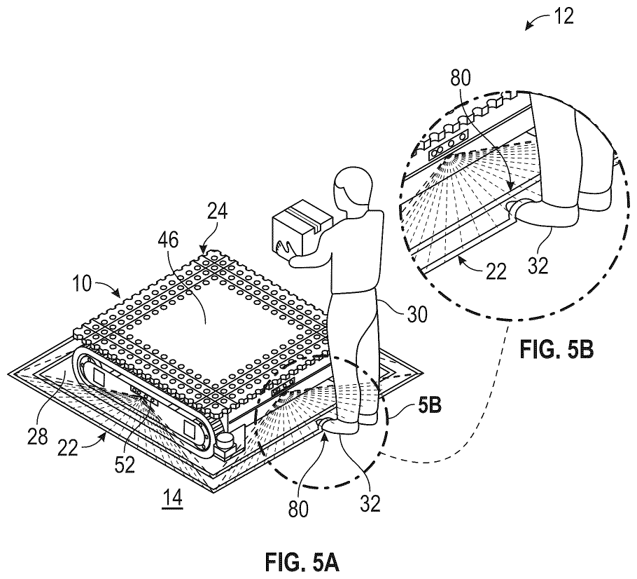

Referring to FIGS. 1A, 3, and 4, the one or more controllers 74 monitor the image data representative of the entirety of the visible light profile 22 collected by the one or more cameras 52 as the ground-based mobility device 10 travels along the surface 14 (FIG. 1A). The one or more controllers 74 continue to monitor the image data until detecting a deviation 80 (shown in FIGS. 5A and 5B) in the predefined pattern of visible light displayed upon the surface 14. The deviation 80 in the predefined pattern of visible light displayed upon the surface 14 is created as an object encroaches upon the visible light profile 22. The deviation 80 represents a distortion within the predefined pattern of visible light displayed upon the surface 14 by the one or more visible light sources 50 created by the object. In the exemplary embodiment as shown in FIGS. 5A and 5B, the deviation 80 is a convex curvature along a straight line that is part of the visible light profile 22, and the object encroaching upon the visible light profile 22 is a foot 32 of the individual 30.

In another implementation, the deviation 80 may be an interruption or an offset in the visible light profile 22. For example, if the object is a vertical wall and the predefined pattern of visible light includes one or more straight lines, then the deviation would include an offset to the straight lines. In other words, the deviation is an offset located where the vertical wall is situated, instead of one or more continuous straight lines. In another example, the deviation 80 may be a complete absence of the visible light profile 22. For example, the visible light profile 22 may disappear completely when there is a drop in the surface 14, such as when the ground-based mobility device 10 approaches a staircase.

In response to detecting the deviation in the predefined pattern of visible light displayed upon the surface, the one or more controllers 74 compare the size of the deviation 80 (shown in FIGS. 5A and 5B) in the predefined pattern of visible light displayed upon the surface 14 with a threshold amount of deviation in the predefined pattern of visible light. It is to be appreciated that the threshold amount of deviation is based on the size of the object that encroaches upon the visible light profile 22 (i.e., the foot 32 shown in FIGS. 5A-5B). The threshold amount of deviation is selected to include objects that are sized to impede travel of the ground-based mobility device 10, and therefore the ground-based mobility device 10 avoids these objects. Some examples of objects that are sized to impede travel of the ground-based mobility device 10 include, but are not limited to, humans, animals, and mobile machinery such as a forklift. At the same time, the threshold amount of deviation is selected to disregard objects that are of a smaller size that is inconsequential to the motion of the ground-based mobility device 10. Some examples of items that are sized so as to be inconsequential to the motion of the ground-based mobility device 10 include bolts, screws, and pieces of refuse such as scraps of paper or food wrappers.

In response to determining the size of the deviation in the predefined pattern of visible light displayed upon the surface is greater than threshold amount of deviation in the predefined pattern of visible light, the one or more controllers 74 instruct the ground-based mobility device 10 to perform one or more predefined actions to avoid contact with the object that encroached upon the visible light profile 22 and to prevent the object from entering the object detection field 28.

The one or more predefined actions include, but are not limited to, ceasing movement of the ground-based mobility device 10, reducing the speed of the ground-based mobility device 10, creating an audio alert, creating a visual alert, and changing the trajectory of the ground-based mobility device 10 to avoid the object. The audio alert and the visual alert are generated so as to capture the attention of an individual encroaching upon the visible light profile 22 (e.g., the individual 30 shown in FIGS. 1A-1B). Specifically, in one example, in response to determining the size of the deviation in the predefined pattern of visible light displayed upon the surface 14 is greater than the threshold amount of deviation in the predefined pattern of visible light, the one or more controllers 74 instruct the drive system 40 to cease movement of the ground-based mobility device 10 to avoid contact with the object that encroaches upon the visible light profile 22.

In one embodiment, the one or more controllers 74 may also execute one or more objection recognition algorithms to identify the object encroaching upon the visible light profile 22. Some examples of object recognition algorithms that may be used include, but are not limited to, a faster region-based convolutional neural network (CNN), single-shot detector (SSD), and the you-only-look-once (YOLO) object detection algorithm. The one or more controllers 74 selects one of the predefined actions based on the identity of the object identified by the one or more object detection algorithms. Specifically, in response to determining the size of the deviation in the predefined pattern of visible light displayed upon the surface 14 is greater than the threshold amount of deviation in the predefined pattern of visible light, the one or more controllers 74 may then execute one or more object detection algorithms to identify the object encroaching upon the visible light profile 22, and then selects one of the predefined actions based on the identity of the object identified by the one or more object detection algorithms.

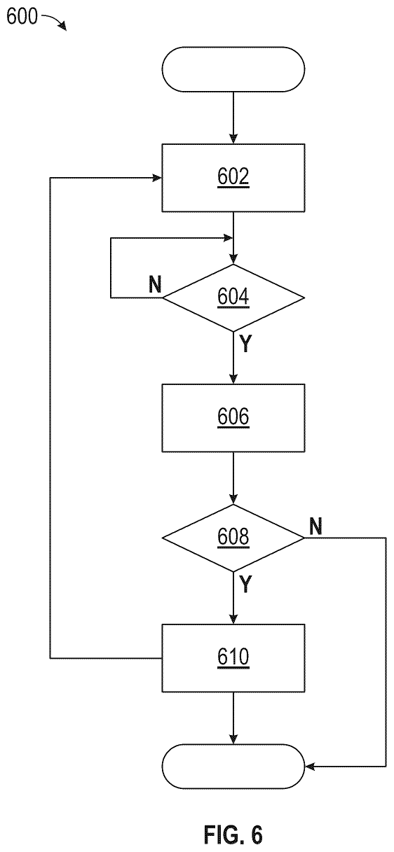

FIG. 6 is a process flow diagram illustrating a method 600 for detecting objects by the visible light indicator system 20. Referring generally to FIGS. 1A, 1B, 2-4, 5A-5B, and 6, the method 600 may begin at block 602. In block 602, the one or more controllers 74 (FIG. 3) monitor the image data collected by the one or more cameras 52 representative of the entirety of the visible light profile 22 as the ground-based mobility device 10 travels along the surface 14. The method 600 may then proceed to decision block 604.

In decision block 604, the one or more controllers 74 continues to monitor the image data until detecting the deviation 80 in the predefined pattern of visible light displayed upon the surface 14, where the deviation 80 in the predefined pattern of visible light displayed upon the surface 14 is created as an object encroaches upon the visible light profile 22. In response to detecting the deviation, the method 600 proceeds to block 606.

In block 606, the one or more controllers 74 compare a size of the deviation 80 in the predefined pattern of visible light displayed upon the surface 14 with a threshold amount of deviation in the predefined pattern of visible light. The method 600 may then proceed to decision block 608.

In decision block 608, in response to determining the size of the deviation 80 in the predefined pattern of visible light upon the surface 14 is equal to or less than the threshold amount of deviation in the predefined pattern of visible light, the one or more controllers 74 determine that the object encroaching upon the visible light profile 22 is inconsequential to the motion of the ground-based mobility device 10. Accordingly, the method 600 may terminate.

Referring to decision block 608, in response to determining the size of the deviation in the predefined pattern of visible light displayed upon the surface 14 is greater than the threshold amount of deviation in the predefined pattern of visible light, the method 600 may proceed to block 610.

In block 610, the one or more controllers 74 instruct the ground-based mobility device 10 to perform one or more predefined actions, where the ground-based mobility device 10 executes the one or more predefined actions to avoid contact with the object that encroached upon the visible light profile 22. The method 600 may terminate or return to block 602.

Referring generally to the figures, the disclosed visible light indication system provides various technical effects and benefits. Specifically, the visible light indication system provides a relatively simple but effective approach to identify the presence of objects that may impede movement of the ground-based mobility device. Additionally, the visible light profile generated by the visible light indication system also serves as a visible indicator of the object detection field to individuals located within the surrounding environment, thereby providing an opportunity for an individual to avoid the ground-based mobility device.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the modules may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A visible light indication system for a ground-based mobility device, the visible light indication system comprising:
one or more visible light sources mounted to a main body of the ground-based mobility device that generate a visible light profile representing a predefined pattern of visible light that is displayed upon a surface that the ground-based mobility device traverses along, wherein the visible light profile extends around a perimeter of the main body of the ground-based mobility device;
one or more cameras positioned on the main body of the ground-based mobility device to collect image data representative of the entirety of the visible light profile;
one or more controllers in electronic communication with the one or more visible light sources and the one or more cameras, wherein the one or more controllers execute instructions to:
monitor the image data representative of the entirety of the visible light profile collected by the one or more cameras as the ground-based mobility device travels along the surface;
detect a deviation in the predefined pattern of visible light displayed upon the surface, wherein the deviation in the predefined pattern of visible light displayed upon the surface is created as an object encroaches upon the visible light profile;
in response to detecting the deviation in the predefined pattern of visible light displayed upon the surface, compare a size of the deviation in the predefined pattern of visible light displayed upon the surface with a threshold amount of deviation in the predefined pattern of visible light;
determine the size of the deviation in the predefined pattern of visible light displayed upon the surface is greater than threshold amount of deviation in the predefined pattern of visible light; and
instruct the ground-based mobility device to perform one or more predefined actions, wherein the ground-based mobility device executes the one or more predefined actions to avoid contact with the object that encroached upon the visible light profile.

2. The visible light indication system of claim 1, wherein the deviation represents a distortion within the predefined pattern of visible light displayed upon the surface created by the one or more visible light sources.

3. The visible light indication system of claim 1, wherein the threshold amount of deviation is based on the size of the object that encroaches upon the visible light profile.

4. The visible light indication system of claim 1, wherein the one or more predefined actions include one or more of the following: ceasing movement of the ground-based mobility device, reducing a speed of the ground-based mobility device, creating an audio alert, creating a visual alert, and changing a trajectory of the ground-based mobility device to avoid the object.

5. The visible light indication system of claim 1, wherein the predefined pattern of visible light includes one or more of the following: one or more straight lines, one or more lines shaped in a zigzag configuration, one or more lines that include a series of dots or dashed lines, letters, and characters.

6. The visible light indication system of claim 1, wherein the one or more visible light sources include one or more of the following: an array of light-emitting diodes (LEDs) and visible light lasers.

7. The visible light indication system of claim 1, wherein the one or more controllers execute instructions to:
instruct the one or more visible light sources to direct the visible light profile including the predefined pattern of visible light in a specific location upon the surface to follow an outer boundary of an object detection field, wherein the object detection represents an area between the main body of the ground-based mobility device and the visible light profile.

8. The visible light indication system of claim 7, wherein the area included by the object detection field is based on a stopping distance of the ground-based mobility device.

9. The visible light indication system of claim 1, wherein the one or more controllers execute one or more objection recognition algorithms to identify the object encroaching upon the visible light profile.

10. A ground-based mobility device, comprising:
a main body; and
a visible light indication system, including:
one or more visible light sources mounted to a main body of the ground-based mobility device that generate a visible light profile representing a predefined pattern of visible light that is displayed upon a surface that the ground-based mobility device traverses along, wherein the visible light profile extends around a perimeter of the main body of the ground-based mobility device;
one or more cameras positioned on the main body of the ground-based mobility device to collect image data representative of the entirety of the visible light profile;
one or more controllers in electronic communication with the one or more visible light sources and the one or more cameras, wherein the one or more controllers execute instructions to:
monitor the image data representative of the entirety of the visible light profile collected by the one or more cameras as the ground-based mobility device travels along the surface;
detect a deviation in the predefined pattern of visible light displayed upon the surface, wherein the deviation in the predefined pattern of visible light displayed upon the surface is created as an object encroaches upon the visible light profile;
in response to detecting the deviation in the predefined pattern of visible light displayed upon the surface, compare a size of the deviation in the predefined pattern of visible light displayed upon the surface with a threshold amount of deviation in the predefined pattern of visible light;
determine the size of the deviation in the predefined pattern of visible light displayed upon the surface is greater than threshold amount of deviation in the predefined pattern of visible light; and
instruct the ground-based mobility device to perform one or more predefined actions, wherein the ground-based mobility device executes the one or more predefined actions to avoid contact with the object that encroached upon the visible light profile.

11. The ground-based mobility device of claim 10, wherein the deviation represents a distortion within the predefined pattern of visible light displayed upon the surface created by the one or more visible light sources.

12. The ground-based mobility device of claim 10, wherein the threshold amount of deviation is based on the size of the object that encroaches upon the visible light profile.

13. The ground-based mobility device of claim 10, wherein the one or more predefined actions include one or more of the following: ceasing movement of the ground-based mobility device, reducing a speed of the ground-based mobility device, creating an audio alert, creating a visual alert, and changing a trajectory of the ground-based mobility device to avoid the object.

14. The ground-based mobility device of claim 10, wherein the predefined pattern of visible light includes one or more of the following: one or more straight lines, one or more lines shaped in a zigzag configuration, one or more lines that include a series of dots or dashed lines, letters, and characters.

15. The ground-based mobility device of claim 10, wherein the one or more visible light sources include one or more of the following: an array of LEDs and visible light lasers.

16. The ground-based mobility device of claim 10, wherein the one or more controllers execute instructions to:
instruct the one or more visible light sources to direct the visible light profile including the predefined pattern of visible light in a specific location upon the surface to follow an outer boundary of an object detection field, wherein the object detection represents an area between the main body of the ground-based mobility device and the visible light profile.

17. The ground-based mobility device of claim 16, wherein the area included by the object detection field is based on a stopping distance of the ground-based mobility device.

18. The ground-based mobility device of claim 10, wherein the ground-based mobility device is one of the following: an autonomous mobile robot, a forklift, a tugger, a golf cart, an airport baggage mover, a plane tugger, a motorized bed, and a motorized stretcher.

19. The ground-based mobility device of claim 10, wherein the ground-based mobility device includes autonomous driving capabilities.

20. A method of detecting objects by a visible light indication system in a ground-based mobility device, the method comprising:
monitor, by one or more controllers, image data representative of the entirety of a visible light profile collected by one or more cameras as the ground-based mobility device travels along a surface that the ground-based mobility device traverses along, wherein one or more visible light sources are mounted to a main body of the ground-based mobility device and generate the visible light profile that represents a predefined pattern of visible light that is displayed upon the surface, and wherein the visible light profile extends around a perimeter of the main body of the ground-based mobility device;
detecting a deviation in a predefined pattern of visible light displayed upon the surface, wherein the deviation in the predefined pattern of visible light displayed upon the surface is created as an object encroaches upon the visible light profile;
in response to detecting the deviation in the predefined pattern of visible light displayed upon the surface, comparing, by the one or more controllers, a size of the deviation in the predefined pattern of visible light displayed upon the surface with a threshold amount of deviation in the predefined pattern of visible light;
determining the size of the deviation in the predefined pattern of visible light displayed upon the surface is greater than threshold amount of deviation in the predefined pattern of visible light;
instructing the ground-based mobility device to perform one or more predefined actions; and
executing, by the ground-based mobility device, the one or more predefined actions to avoid contact with the object that encroached upon the visible light profile.
